(19) United States
(12) Patent Application Publication
(10) Pub. No.: US 2013/0103874 A1
(43) Pub. Date: Apr. 25, 2013

(54) UPGRADE SYSTEM FOR POWER SUPPLY UNIT

(71) Applicants: YU-CHI TSAI, Tu-Cheng (TW); KUEI-CHIH HOU, Tu-Cheng (TW)

(72) Inventors: YU-CHI TSAI, Tu-Cheng (TW); KUEI-CHIH HOU, Tu-Cheng (TW)

(73) Assignee: HON HAI PRECISION INDUSTRY CO., LTD., Tu-Cheng (TW)

(21) Appl. No.: 13/441,850

(22) Filed: Apr. 7, 2012

(30) Foreign Application Priority Data
Oct. 20, 2011 (TW) 100138173

(51) Int. Cl. G06F 13/14

(52) U.S. Cl. 710/305

(57) ABSTRACT

An upgrade system for a power supply unit. The power supply unit includes a master interface for outputting power. The upgrade system includes a test board with a slave interface and an upgrade interface, and an upgrade device. Each of the master interface and the slave interface includes four reserved pins. The four reserved pins of the master interface are correspondingly connected to the four reserved pins of the slave interface. The four reserved pins of the slave interface are further connected to the upgrade interface. The upgrade device communicates with the power supply unit through the upgrade interface and the reserved pins of the master interface and the slave interface.

### BACKGROUND

1. Technical Field

The present disclosure relates to a system for upgrading power supply units.

2. Description of Related Art

Software is embedded in power supply units which supply power for servers. For different servers, power supply units with different software are needed. To upgrade the software embedded in a power supply unit, the power supply unit includes an added interface, which is regarded as an upgrade interface, to be connected to an upgrade device. In other words, the power supply unit must include the upgrade interface, which is costly.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a block diagram of an exemplary embodiment of an upgrade system for a power supply unit, wherein the power supply unit includes a master interface, the upgrade system includes a slave interface, a test board, and an upgrade interface.

FIG. 2 is a circuit diagram of the master interface, the slave interface, the test board, and the upgrade interface of FIG. 1.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean at least one.

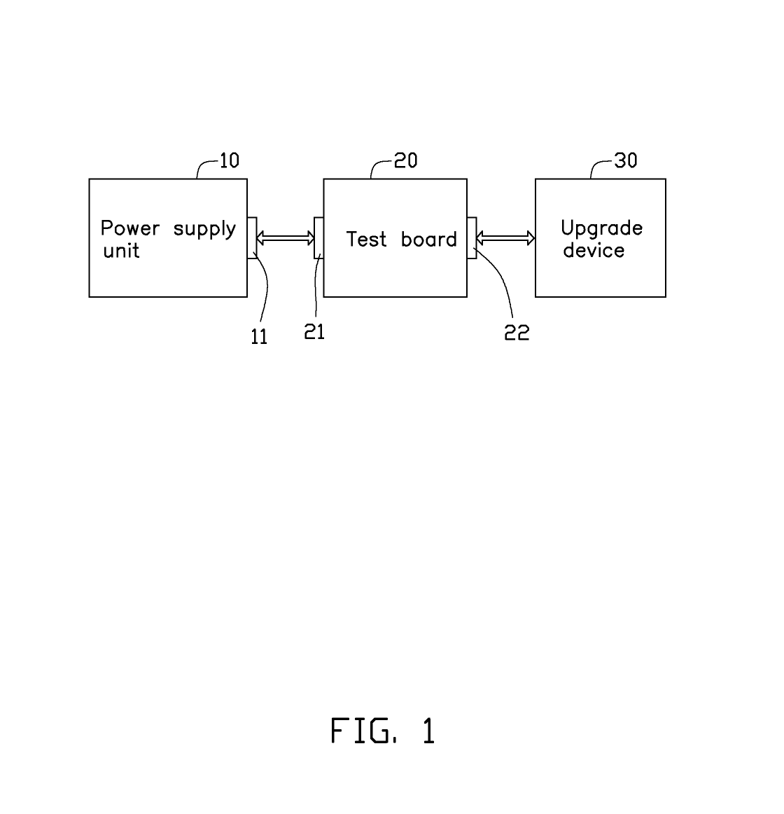

Referring to FIG. 1, an exemplary embodiment of an upgrade system for upgrading a power supply unit 10 includes a test board 20 and an upgrade device 30. A master interface 11 is arranged on the power supply unit 10, which can be connected to electronic devices to supply power to the electronic devices. A slave interface 21 and an upgrade interface 22 are arranged on the test board 20. The upgrade interface 22 is connected between the upgrade device 30 and the power supply unit 10. In this embodiment, when the power supply unit 10 needs not to be upgraded, the master interface 11 of the power supply unit 10 is connected to a server for supplying power to the server. When the power supply unit 10 needs to be upgraded, the master interface 11 of the power supply unit 10 is connected to the slave interface 21 of the test board 20.

Table 1 shows definitions for some of the pins of the master interface 11 and the slave interface 21. The pins of the master interface 11 and the slave interface 21 each include at least four reserved pins S14, S16, S21, and S24, and a plurality of signal pins S2-S13, S15, S17-S20, S22, and S23. When the master interface 11 of the power supply unit 10 is connected to the electronic devices for supplying power, the signals pins S2-S13, S15, S17-S20, S22, and S23 of the master interface 11 transmit power to the electronic devices, and the reserved pins S14, S16, S21, and S24 do not transmit signals between the power supply unit 10 and the electronic devices.

TABLE 1

| Pins | Definition | Pins | Definition |
|---|---|---|---|
| S2 | open | S14 | Reserved¹ |
| S3 | +VSENSE | S15 | ADDR |
| S4 | PS_KILL | S16 | Reserved² |
| S5 | open | S17 | ENABLE# |
| S6 | DC_GOOD | S18 | EPOW# |
| S7 | PRESENT# | S19 | EFS# |
| S8 | SMBus_ALERT# | S20 | Throttle# |
| S9 | ISHARE | S21 | Reserved³ |
| S10 | GND | S22 | −VSENSE |
| S11 | SDA | S23 | open |
| S12 | SCL | S24 | Reserved⁴ |
| S13 | SMBus_reset# | | |

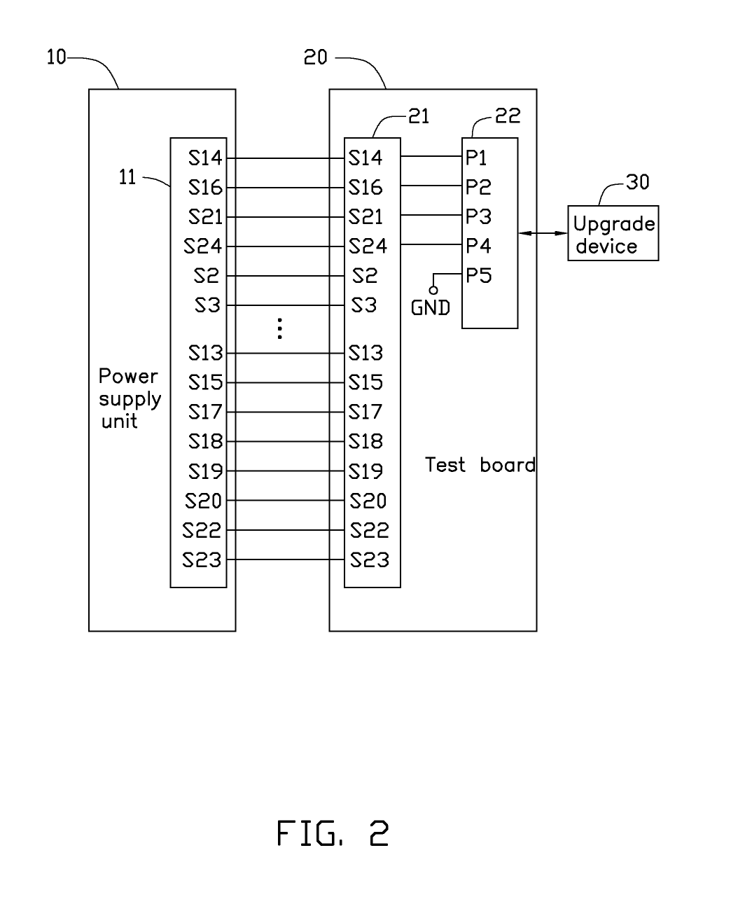

Referring to FIG. 2, the upgrade interface 22 includes five pins P1-P5. The reserved pins S14, S16, S21, and S24 of the slave interface 21 are respectively connected to the pins P1-P4 of the upgrade interface 22. The pin P5 of the upgrade interface 22 is connected to a ground pin GND of the test board 20.

When software embedded in the power supply unit 10 needs to be upgraded, the master interface 11 of the power supply unit 10 is connected to the slave interface 21 of the test board 20, and the upgrade interface 22 of the test board 20 is connected to the upgrade device 30. The reserved pins S14, S16, S21, and S24 of the master interface 11 are correspondingly connected to the reserved pins S14, S16, S21, and S24 of the slave interface 21. The upgrade device 30 is then started, and the upgrade device 30 upgrades the software embedded in the power supply unit 10 through the pins P1-P4 of the upgrade interface 22 on the test board 20, and the reserved pins S14, S16, S21, and S24 of the slave interface 21 and the master interface 11. In this state, the signal pins S2-S 13, S15, S17-S20, S22, and S23 of the master interface 11 do not transmit signals between the power supply unit 10 and the test board 20.

In this embodiment, the upgrade interface 22 is arranged on the test board 20. As a result, the software embedded in the power supply unit 10 can be upgraded through the master interface 11, thus a separate upgrade interface does not need to be arranged on the power supply unit 10.

The foregoing description of the exemplary embodiments of the disclosure has been presented only for the purposes of illustration and description and is not intended to be exhaustive or to limit the disclosure to the precise forms disclosed. Many modifications and variations are possible in light of everything above. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than the foregoing description and the exemplary embodiments described therein.

What is claimed is:

1. An upgrade system for a power supply unit comprising a master interface for outputting power, the upgrade system comprising:
a test board comprising a slave interface to be connected to the master interface of the power supply unit, and an upgrade interface; and
an upgrade device connected to the upgrade interface of the test board;
wherein each of the master interface and the slave interface comprises four reserved pins, the reserved pins of the master interface are corresponding connected to the reserved pins of the slave interface, the reserved pins of the slave interface are further connected to the upgrade interface, the upgrade device communicates with the power supply unit through the upgrade interface and the reserved pins of the master interface and the slave interface.

2. The upgrade system of claim 1, wherein the slave interface of the test board further comprises a plurality of signal pins connected to a plurality of signal pins of the master interface of the power supply unit, the signal pins of the master interface of the power supply unit are to output power.

3. The upgrade system of claim 2, wherein the upgrade interface of the test board comprises five pins, four pins of the update interface are correspondingly connected to the four reserved pins of the slave interface of the test board, a fifth pin of the upgrade interface is connected to a ground pin of the test board.
